(19) United States
(12) Patent Application Publication
(10) Pub. No.: US 2020/0010134 A1
(43) Pub. Date: Jan. 9, 2020

(54) Bicycle Saddle

(71) Applicant: Ergon International GmbH, Koblenz (DE)

(72) Inventors: Andreas Krause, Koblenz (DE); Christine Juckwer, Koblenz (DE)

(21) Appl. No.: 16/459,818

(22) Filed: Jul. 2, 2019

(30) Foreign Application Priority Data
Jul. 3, 2018 (DE) 20 2018 003 082.1

(51) Int. Cl. B62J 1/00; B62J 1/08; B62J 1/26

(52) U.S. Cl. CPC B62J 1/007; B62J 1/08; B62J 9/006; B62J 1/002; B62J 1/26

(57) ABSTRACT

A bicycle saddle includes a saddle shell connected to a saddle rail, a padding element arranged on an upper side of said saddle shell, and a deepened portion extending in said padding element in the longitudinal direction of the bicycle saddle. The depth of said deepened portion increases towards a rear side of the saddle.

### CROSS-REFERENCE TO RELATED APPLICATION

This application claims priority to German Utility Model Application No. 20 2018 003 082.1 filed Jul. 3, 2018, the disclosure of which is hereby incorporated by reference in its entirety.

### BACKGROUND OF THE INVENTION

### Field of the Invention

The invention relates to a bicycle saddle, in particular a saddle for a man's bicycle.

### Description of Related Art

Bicycle saddles comprise a saddle shell in particular made from a hard plastic material. The lower side of the saddle shell is connected to a saddle rail. The saddle rail serves for connecting the saddle to the seat post. On an upper side of the saddle shell a padding element made of a padding material is arranged. The padding element is normally provided with a cover which is fixed on the lower side of the saddle shell. In particular for relieving the genital area, bicycle saddles are known which comprise a longitudinal deepened portion in the padding element or a continuous slot. When the bicycle saddle is mounted, such a slot or such a deepened portion thus extends in the direction of travel, i.e. in the longitudinal direction of the saddle.

The provision of deepened portions in the padding element is disadvantageous in that rainwater may collected therein. Further, a deepened portion in the padding element is disadvantageous in that the padding element is very thin in the genital area, and in particular in the case of a low or lowermost position of the handlebar an unpleasant pressure is exerted onto the genital area. The provision of continuous slots open in a downward direction is disadvantageous in that splash water may penetrate the slot. Further, the provision of such a slot is disadvantageous in that the stability of the saddle shell is reduced. Thus, in such saddles it would be necessary to provide a large amount of glass fiber reinforced material or the like in the saddle shell, which, however, would result in the material of the saddle shell becoming brittle.

### SUMMARY OF THE INVENTION

It is an object of the invention to provide an improved bicycle saddle.

According to the invention, this object is achieved by a bicycle saddle according to the present disclosure.

The bicycle saddle according to the invention comprises a deepened portion provided in the padding element and extending in the longitudinal direction of the bicycle saddle. According to the invention, the depth of the deepened portion increases towards the rear side of the saddle. The depth thus increases counter to the direction of travel. When the bicycle saddle is mounted, the deepened portion is thus tilted counter to the direction of travel. According to a particularly preferred embodiment of the bicycle saddle according to the invention, an opening is arranged in the saddle shell in the area of the deepened portion on the rear side of the saddle. In the mounted condition, this opening is preferably arranged at the lowermost location of the deepened portion. In this particularly preferred embodiment of the invention, the opening of the saddle shell, which communicates with the deepened portion, is thus arranged in the back area or the area on the rear side of the saddle, in particular at the end of the deepened portion on the rear side of the saddle. In particular, the deepened portion ends in the opening. Further, the deepened portion may comprise, in the area on the rear side of the saddle, a portion that is tilted in the direction of travel. As seen in the side view, the deepened portion is thus V-shaped, for example.

The provision of a deepened portion instead of a slot offers the advantage that no splash water can penetrate a slot. Further, the deepened portion becoming increasingly deeper counter to the direction of travel offers the advantage that thus the genital area is more strongly relieved. The particularly preferred embodiment of the invention, where the deepened portion in the area on the rear side of the saddle comprises an opening, further offers the advantage that moisture, such as rain water, can flow out of the deepened portion. Further, in the embodiment of the padding element comprising a deepened portion according to the invention, it is possible to provide an essentially continuous saddle shell or a saddle shell without any interruptions. Thereby, a saddle shell having a high strength while offering a desired flexibility can be realized. A reinforcement of the saddle shell with a high glass fiber content, as is required in the case of saddles with a longitudinal slot in the saddle shell, is not necessary.

Preferably, the deepened portion extends from an area of a saddle tip up to the seating area of a saddle.

It is further preferred that the deepened portion is of a stepless configuration in the longitudinal direction. The deepened portion starts in a stepless manner in particular in the area of the saddle tip such that the deepened portion starts on an upper side of the padding element. Merely in the end portion of the deepened portion, that is in the area on the rear side of the saddle, a step is provided. The latter is in particular arranged in the seating area of the saddle.

In addition, it is preferred that the deepened portion has a maximum depth with respect to an upper side of the padding of at least 5 millimeters, in particular at least 7 millimeters and particularly preferred at least 9 millimeters. The width of the deepened portion, that is the dimension of the deepened portion crosswise to the longitudinal direction, preferably increases in the longitudinal direction. The depth of the deepened portion is thus preferably smaller in the area of the saddle tip than in the seating area. The width of the deepened portion is preferably in the range of 5-30 millimeters, wherein the deepened portion preferably has a width of 5-10 millimeters in the front area and preferably has a width of 15-30 millimeters in the seating area.

According to the particularly preferred embodiment of the saddle according to the invention, where the saddle shell comprises an opening communicating with the deepened portion, the opening preferably essentially extends over the overall width of the deepened portion. In the longitudinal direction, the opening preferably has opening dimensions of 5-10 millimeters. Due to the relatively small opening, there is only little risk of entering splash water.

According to a preferred aspect, the saddle shell comprises a collar in the area of the opening. The latter extends into the opening and is preferably of a completely circumferential configuration. The collar serves for constituting a defined termination for a padding element provided on the upper side of the saddle shell.

According to a particularly preferred aspect of the invention, the saddle shell comprises on a lower side an indentation extending towards the deepened portion. In particular, the indentation extends over the overall length of the deepened portion. Thereby, it is possible to realize a deepened portion with a large depth such that good relieving of the genital area is ensured. Further, this offers the advantage that on the base, that is on the lower side of the deepened portion, a padding element can be provided such that this area, too, is padded. The padding thus realizable in the deepened portion of this embodiment offers the advantage that even in a low or lowermost handlebar position a good pressure distribution is possible and thus in this position a preferred padding or damping in the genital area can be realized. The provision of an indentation in the longitudinal direction of the saddle shell in connection with a deepened portion in the padding element may be independent of the tilt of the deepened portion and of the provision of an opening in the saddle shell as well as of the provision of a holding element. According to a preferred aspect of this invention, these elements are, however, at least partly provided.

In addition, it is preferred that the saddle shell has a smaller thickness or a smaller wall thickness in the area of the indentation than in the remaining area. Thereby, the flexibility can be improved. In particular, in the area of the indentation the saddle shell has a thickness of less than 2.5 millimeters, in particular less than 2 millimeters, and particularly preferred a wall thickness in the range of 1.5 millimeters. In particular in areas adjacent to the indentation, the saddle shell preferably has a thickness of more than 2 millimeters, wherein in particular a thickness in the range of 2.5 millimeters is preferred.

According to a particularly preferred aspect of the invention, the opening comprises a holding element in its edge area. This holding element in particular serves for fixing a saddlebag, a small toolbox, a rear light, a holding fixture for a spare bicycle tube, or for fixing a splash guard. This feature may be independent of the tilt of the deepened portion and/or the provision of an indentation in the saddle shell. According to a preferred aspect, a saddle having a holding element according to the invention additionally comprises some of the features described above regarding the deepened portion and/or the indentation.

Preferably, the holding element is constituted by the saddle shell, wherein it is preferred that the holding element extends towards the padding element. For example, the holding element may comprise locking elements and the like such that a saddlebag can be fixed in a simple manner, for example.

Preferably, the holding element is arranged on a front side of the opening. Here, the front side of the opening is the side of the opening pointing in the direction of travel. This offers the advantage that a saddlebag or the like can be fixed in a simple manner in the direction of travel, that is from the rear side of the saddle, for example.

In addition, it is preferred that the front side of the opening has a height offset with respect to an opposite rear side of the opening. In particular, in the mounted condition, the rear side is higher than the front side. This offers the advantage that the front side of the opening comprising and/or constituting the holding element is easily accessible from the rear side of the saddle.

In addition, it is possible to provide a fastening element at the saddle shell. The fastening element is in particular provided in the rear edge area of the saddle shell provided in the back portion or pointing counter to the direction of travel. This is in particular the area between the two fastening points of the saddle rail in the rear area of the saddle shell. The edge area of the saddle shell can be of a somewhat thicker configuration in this area such that a fasting element can be provided which is fixed by a screw, for example. At this fastening element a saddlebag, a toolbox, a rear light, a splash guard or the like can be fixed with the aid of locking connections, for example. Preferably, the additional component is fastened to the fastening element by a locking connection such that the corresponding element, such as a saddlebag, can be easily inserted from the rear side and fastened by locking. The bag can be released in a simple manner by normal unlocking of the locking connection.

In particular, the fastening element can be provided independent of or in addition to the holding element. When the fastening element is provided in connection with the holding element, it is in particular possible to connect a saddlebag or the like to the saddle shell at two locations, namely at the holding element and at the fastening element. Thereby, it is possible on the one hand to fasten heavy saddlebags, toolboxes and the like, and on the other hand fastening at two locations offers the advantage of an improved position definition. This is in particular preferable when a splash guard is attached.

According to a particularly preferred aspect of the invention, the saddle shell comprises an indentation extending on a lower side towards the deepened portion. In particular, the indentation extends over the overall length of the deepened portion. Thereby, it is possible to realize a deepened portion having a large depth such that good relieving of the genital area is ensured. Further, this offers the advantage that in the base, that is on the lower side of the deepened portion a padding element can be provided such that this area, too, is padded.

### BRIEF DESCRIPTION OF THE DRAWINGS

Hereunder the invention is explained in detail on the basis of a preferred embodiment with reference to the accompanying drawings in which:

FIG. 1 shows a schematic top view of a bicycle saddle according to the invention,

FIG. 2 shows a schematic sectional view along a line II-II of FIG. 1,

FIG. 3 shows a schematic sectional view along a line III-III of FIG. 1, and

FIG. 4 shows a schematic sectional view in the longitudinal direction of the saddle shell.

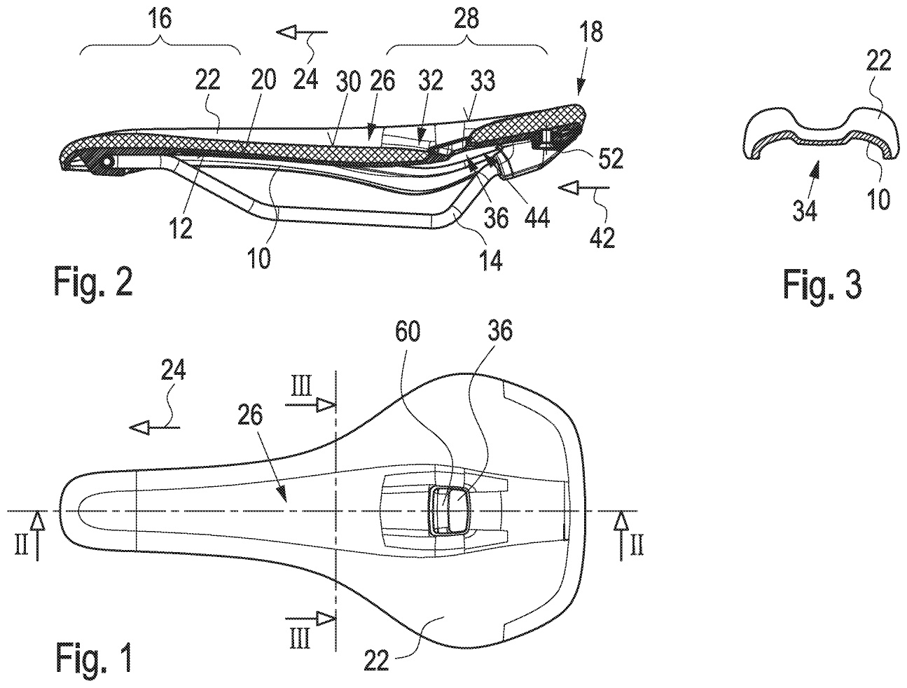

### DETAILED DESCRIPTION OF THE INVENTION

The preferred embodiment of a bicycle saddle according to the invention illustrated in the figures comprises a saddle shell 10. On a lower side 12 of the saddle shell 10 a saddle rail is arranged which comprises two seat stays 14 in the illustrated exemplary embodiment. The ends of the stays are connected to the saddle shell 10 in the area of a saddle tip 16 on the one hand and in the area of a rear side 18 on the other hand.

On an upper side 20 of the saddle shell a padding element 22 is arranged. The padding element 22 is provided with a cover not illustrated which, in the edge area on the lower side 12, is connected to the saddle shell 10.

In the longitudinal direction 24, that is in the direction of travel in the mounted condition, a deepened portion 26 extends in the saddle padding 22. The deepened portion 26 extends from the area 16 of the saddle tip into a seating area 28. A lower side 30 of the deepened portion 26 or the base of the deepened portion 26 is configured such that the depth of the deepened portion 26 increases counter to the direction of travel 24, that is towards the rear side 18 of the saddle. In the area of the saddle tip, where the deepened portion 26 starts in the illustrated embodiment, first the depth is 0 millimeter and then increases, towards a rear area 32, to a depth of approximately 10 millimeters with respect to an adjacent upper side 33 of the padding.

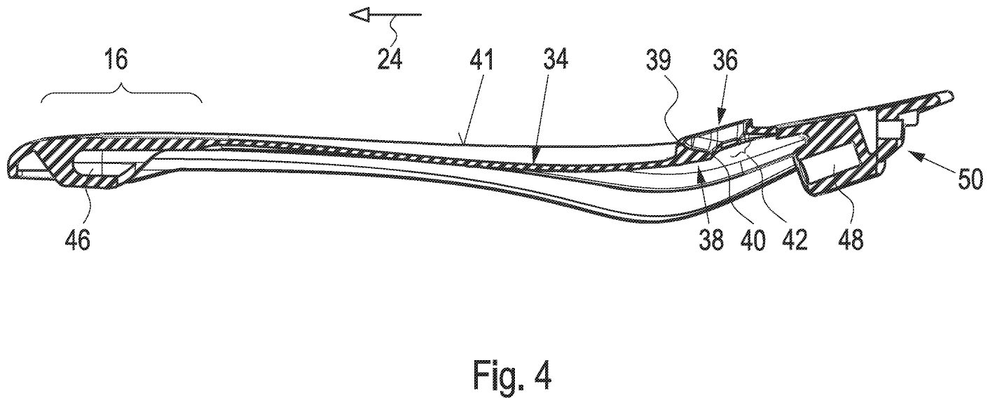

In the illustrated embodiment, the saddle shell 10 comprises, on the lower side 12, an indentation 34 extending over the overall length of the deepened portion 26 (FIGS. 3 and 4). Thereby, it is possible to also provide an adequate thickness of the padding element 32 even in the deepened portion 26.

According to the particularly preferred embodiment of the invention, the saddle shell comprises an opening 36. The opening 36 is arranged in the rear area, in particular at the end of the deepened portion 26. The deepened portion 26 thus ends, counter to the direction of travel, in the opening 36. The opening 36 in the saddle shell 10 thus directly communicates with the deepened portion 26.

In the illustrated exemplary embodiment, the indentation 34 starts in the area of the saddle tip 16 with respect to the direction of travel 24. In this area, the indentation starts in a stepless manner and thus has a difference of 0 millimeter with respect to the portion of the saddle shell 10 arranged beside the indentation. As is in particular shown in FIG. 4, counter to the direction of travel 24, the height difference with respect to the area 41 of the saddle shell 10 considerably increases directly beside the indentation 34.

In a front edge area 38, the saddle shell comprises a bulge or an edge 39. The latter serves in particular for accommodating the saddle padding 22 such that an in particular neat and ridge-free edge area of the padding can be realized. Thereby, the padding is prevented from detaching or being damaged in this area. In particular, the edge 39 is of a circumferential configuration and completely surrounds the opening 36. In addition, in the area of the saddle tip 16 as well as in the area of the rear side 28 of the saddle, the saddle shell 10 comprises recesses 46, 48 for accommodating the saddle rail 14.

In the area of the indentation 34, the saddle shell 10 preferably has a smaller thickness or a smaller wall thickness than in its adjacent area 41 (FIG. 3).

In the front edge area 38 (FIG. 4), the opening 36 comprises a holding element 40. The holding element 40 is in particular easily accessible from a rear side of the saddle due to the height difference 42 and serves for fastening a saddlebag, a small toolbox, a rear light, a holding fixture for a spare bicycle tube, a splash guard or the like, for example.

In addition, in a rear area 50, in particular between the two portions 48 for accommodating the saddle rail 14, a fastening element (not illustrated) may be provided. The fastening element can in particular be fastened by means of a screw 52 (FIG. 2). The fastening element, which is in particular a fastening element comprising a locking means, serves for accommodating a saddlebag, a toolbox, a rear light, a splash guard or the like. In particular, such a fastening element can cooperate with the holding element 40 such that heavier saddlebags can also be fastened or a splash guard is easy to align, for example.

In the illustrated mounted condition, the rear side 44 is higher than the front side 38. Thereby, the accessibility of the holding element 40 is improved. In particular due to the height offset 42, the configuration of the saddle shell having an indentation 34 extending in the longitudinal direction can well be seen when viewing the saddle from the rear. The technical advantage of the indentation is thus recognizable for the user.

1. A bicycle saddle, comprising
a saddle shell connected to a saddle rail,
a padding element arranged on an upper side of said saddle shell, and
a deepened portion extending in said padding element in a longitudinal direction of the bicycle saddle,
wherein
the depth of said deepened portion increases towards a rear side of the saddle.

2. The bicycle saddle according to claim 1, wherein the deepened portion extends from an area of the saddle tip into a seating area.

3. The bicycle saddle according to claim 1, wherein the deepened portion is of a stepless configuration in the longitudinal direction.

4. The bicycle saddle according to claim 1, wherein the deepened portion has a maximum depth with respect to an upper side of the padding of at least 5 millimeters.

5. The bicycle saddle according to claim 1, wherein the saddle shell comprises an opening communicating with the deepened portion.

6. The bicycle saddle according to claim 5, wherein the opening comprises a circumferential collar extending towards the saddle padding.

7. The bicycle saddle according to claim 5, wherein in an edge area of the opening a holding element is provided for fixing a saddlebag.

8. The bicycle saddle according to claim 7, wherein the saddle shell comprises the holding element.

9. The bicycle saddle according to claim 7, wherein the holding element extends towards the padding element.

10. The bicycle saddle according to claim 7, wherein the holding element is arranged on a front side of the opening.

11. The bicycle saddle according to claim 10, wherein the front side of the opening comprises a height offset with respect to a rear side of the opening.

12. The bicycle saddle according to claim 1, wherein the saddle shell comprises an indentation provided on a lower side and extending towards the deepened portion.

13. The bicycle saddle according to claim 1, wherein the deepened portion has a maximum depth with respect to an upper side of the padding of at least 7 millimeters.

14. The bicycle saddle according to claim 1, wherein the deepened portion has a maximum depth with respect to an upper side of the padding of at least 9 millimeters.

15. The bicycle saddle according to claim 5, wherein the opening is arranged in an area of the deepened portion on the rear side of the saddle.
